(19) United States
(12) Patent Application Publication
(10) Pub. No.: US 2026/0313685 A1
(43) Pub. Date: Oct. 8, 2026

(54) DEVICES, METHODS AND MEDIUM FOR SIDELINK COMMUNICATIONS

(71) Applicant: LENOVO (BEIJING) LIMITED, Beijing (CN)

(72) Inventors: Xiaodong YU, Beijing (CN); Haipeng LEI, Beijing (CN); Zhennian SUN, Beijing (CN); Xin GUO, Beijing (CN)

(21) Appl. No.: 19/482,468

(22) PCT Filed: May 15, 2023
(86) PCT No.: PCT/CN2023/094369

§ 371 Date: Nov. 7, 2025

(51) Int. Cl. H04W 74/0808

(52) U.S. Cl. CPC H04W 74/0808

(57) ABSTRACT

Embodiments of the present disclosure relate to devices, methods and a medium for sidelink communications. In an aspect, a terminal device receives, from a network device, configuration information indicating at least one set of candidate starting positions for a cyclic prefix extension (CPE). The at least one set of candidate starting positions are determined based on a listen before talk (LBT) type. Then, the terminal device determines, based on the configuration information, to perform or skip a data transmission on a symbol within a slot occupied by the terminal device for a sidelink transmission. In this way, the sidelink communication performance can be improved.

### FIELD

Embodiments of the present disclosure generally relate to the field of communication, and in particular to terminal devices, a network device, methods, and a non-transitory computer readable medium for sidelink communications.

### BACKGROUND

In telecommunications networks, such as long term evolution (LTE) networks or new radio (NR) networks, sidelink communications between user equipment (UEs) over a wireless interface may be supported. In sidelink communications, UEs may communicate with each other directly via, for example, a PC5 wireless interface on a sidelink channel. The sidelink communications may obtain a plurality of benefits, such as coverage extension, service reliability enhancement, and potential low latency.

In some cases, the terminal devices may communicate with each other on unlicensed sidelink (SL-U) resources (e.g., on SL-U channels). Specifically, by means of channel contention procedure or a channel access procedure (for example, a listen before talk, LBT, procedure), a terminal device may initiate a channel occupancy time (COT), for example, 4 ms or 10 ms based on regional regulation requirement, on certain resources of sidelink resource pool in unlicensed band. This terminal device initiating the COT may be also referred to as COT initiating UE. If the COT is redundancy to the COT initiating UE (for example, the data transmission is completed, but there is still remaining COT), the COT initiating UE may share a part of initiated COT (for example, one or more slots) to other terminal devices that may be also referred to as COT responding UEs. The COT responding UE may occupy the shared COT based on similar channel contention procedure. In some situations, the contention arrangement for the COT or shared COT may be further optimized.

### SUMMARY

In general, embodiments of the present disclosure provide a solution for sidelink communications.

In a first aspect, there is provided a terminal device. The terminal device comprises a processor and a transceiver coupled to the processor. The processor is configured to receive, via the transceiver from a network device, configuration information indicating at least one set of candidate starting positions for a cyclic prefix extension (CPE). The at least one set of candidate starting positions the at least one set of candidate starting positions are determined based on a listen before talk (LBT) type. The processor is further configured to determine, based on the configuration information, to perform or skip a data transmission on a symbol within a slot occupied by the terminal device for a sidelink transmission.

In a second aspect, there is provided a terminal device. The terminal device comprises a processor and a transceiver coupled to the processor. The processor is configured to receive, via the transceiver from a network device, configuration information indicating at least one set of candidate starting positions for CPE. The at least one set of candidate starting positions are determined based on an LBT type. The processor is configured to determine a target LBT type based on a resource configuration for the terminal device or a received control channel transmission. The processor is further configured to select, based on the target LBT and the configuration information, a target starting position from the at least one set of candidate starting positions for occupying a sidelink channel.

In a third aspect, there is provided a network device. The network device comprises a processor and a transceiver coupled to the processor. The processor is configured to determine at least one set of candidate starting positions for CPE based on an LBT type. The processor is further configured to transmit, via the transceiver to at least one terminal device, configuration information indicating the at least one set of candidate starting positions for CPE.

In a fourth aspect, there is provided a method performed by a terminal device. In the method, the terminal device receives, from a network device, configuration information indicating at least one set of candidate starting positions for a CPE. The at least one set of candidate starting positions are determined based on an LBT type. Then, the terminal device determines, based on the configuration information, to perform or skip a data transmission on a symbol within a slot occupied by the terminal device for a sidelink transmission.

In a fifth aspect, there is provided a method performed by a terminal device. In the method, the terminal device receives, from a network device, configuration information indicating at least one set of candidate starting positions for CPE. The at least one set of candidate starting positions are determined based on an LBT type. The terminal device determines a target LBT type based on a resource configuration for the terminal device or a received control channel transmission. Then, the terminal device selects, based on the target LBT and the configuration information, a target starting position from the at least one set of candidate starting positions for occupying a sidelink channel.

In a sixth aspect, there is provided a method performed by a network device. In the method, the network device determines at least one set of candidate starting positions for CPE based on an LBT type. Then, the network device transmits, to at least one terminal device, configuration information indicating the at least one set of candidate starting positions for CPE.

In a seventh aspect, there is provided a non-transitory computer readable medium. The non-transitory computer readable medium having program instructions stored thereon. The program instructions, when executed by an apparatus, causing the apparatus at least to perform the method of any of the third aspect to the sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1A illustrates a schematic diagram of a communication environment in which some embodiments of the present disclosure can be implemented;

FIG. 1B illustrates an example of a set of starting positions for CPE in Option 1;

FIG. 1C illustrates an example of a set of starting positions for CPE in Option 2;

FIG. 1D illustrates an example arrangement comprising candidate starting positions for CPE and a data transmission in an occupied slot;

FIG. 1E illustrates an example arrangement comprising LBT procedure and a candidate starting position for CPE in an occupied slot;

FIGS. 1F, 1G and 1H illustrate an example association between an LBT procedure, symbol boundary and a candidate starting position for CPE in an occupied slot;

FIG. 2 illustrates an example signaling process for configuring a set of candidate starting positions associated with LBT type according to some example embodiments of the subject disclosure;

FIGS. 3A, 3B and 3C illustrate an example configuration of a set of candidate starting positions for CPE under a first LBT type in accordance with some embodiments of the present disclosure;

FIGS. 4A, 4B and 4C illustrate another example configuration of another set of candidate starting positions for CPE under a second LBT type in accordance with some embodiments of the present disclosure;

FIG. 5 illustrates an example flowchart of a method implemented at a terminal device according to example embodiments of the present disclosure;

FIG. 6 illustrates an example flowchart of a method implemented at a terminal device according to example embodiments of the present disclosure;

FIG. 7 illustrates an example flowchart of a method implemented at a network device according to example embodiments of the present disclosure; and

FIG. 8 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments.” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

As used herein, the term “LBT type” may refer to a type of the LBT procedure. In an example, the LBT type may comprise LBT type 1, LBT type 2A, LBT type 2B, and LBT type 2C. In some cases, the LBT procedure having the LBT type 1 may have the largest duration, the LBT procedure having the LBT type 2A or 2B may have a smaller duration, for example, 25 us or 16 us. The LBT procedure having the LBT type 2C may have the smallest duration, for example, 0 us. Without any limitation, in an example, the COT initiating UE may initiate a COT on an unlicensed channel by using the LBT procedure having the LBT type 1. In turn, if the COT initiating UE is to share remaining COT, other COT responding UE may perform the LBT procedure having the LBT types 2A, 2B or 2C to contend the remaining COT on the unlicensed sidelink channel.

As used herein, the term “starting position” may refer to the position for the terminal device to start transmitting a cyclic prefix extension (CPE) for occupying an unlicensed sidelink channel. In some cases, there is a plurality of candidate starting positions, and the terminal device may select a target starting position based on associated priority. Furthermore, the number of candidate starting positions within in a time unit may be specific to the configured subcarrier spacing (SCS). If the SCS is wider, the number may be smaller. Without any limitation, in this disclosure, the terms “starting position”, “starting position for CPE” or “CPE starting position” may be used interchangeably.

In general, after performing the LBT procedure and determining that the unlicensed sidelink channel is clear, a terminal device contending the unlicensed channel may transmit a cyclic prefix extension (CPE) for occupying the unlicensed sidelink channel. The starting positions of transmitting CPE may be differently determined for different traffic priorities from terminal devices. In an example, if a traffic from terminal device has a higher priority (for example, the traffic associated with the terminal device is more urgent), the starting position for the terminal device to transmit the CPE may be earlier than other terminal devices, such that this terminal device can occupy the unlicensed sidelink channel earlier. In turn, if other terminal devices are still performing the LBT procedure (because the starting position for other terminal device to transmit the CPE is later), the other terminal devices may determine that the unlicensed sidelink channel is busy and will not occupy the unlicensed sidelink channel. In other words, the starting time for performing the LBT procedure by a terminal device is determined based on the starting position configured for the terminal device to transmit the CPE.

As mentioned above, the contention arrangement for the COT or shared COT may be further enhanced.

In one solution, there are two options for configuring the starting positions of the CPE. In the first option (which may be also referred to as Option 1), if a slot is to be shared or occupied, the candidate starting positions is configured within the last symbol of another slot previous to the slot that is to be shared or occupied. In the second option (which may be also referred to as Option 2), if the SCS is 15 kHz, the candidate starting positions is configured within the last symbol of another slot previous to the slot that is to be shared or occupied. Else, if the SCS is 30 kHz or 60 kHz, the candidate starting positions is configured within the last two symbols of another slot previous to the slot that is to be shared or occupied.

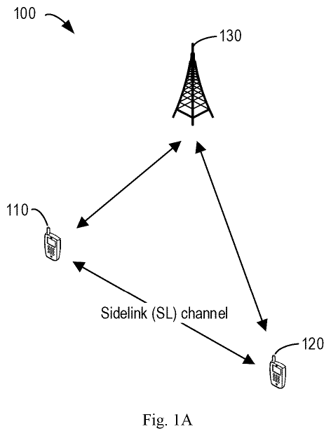

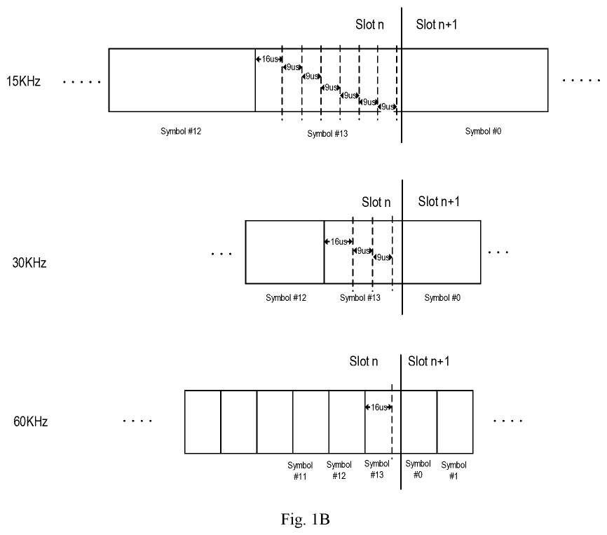

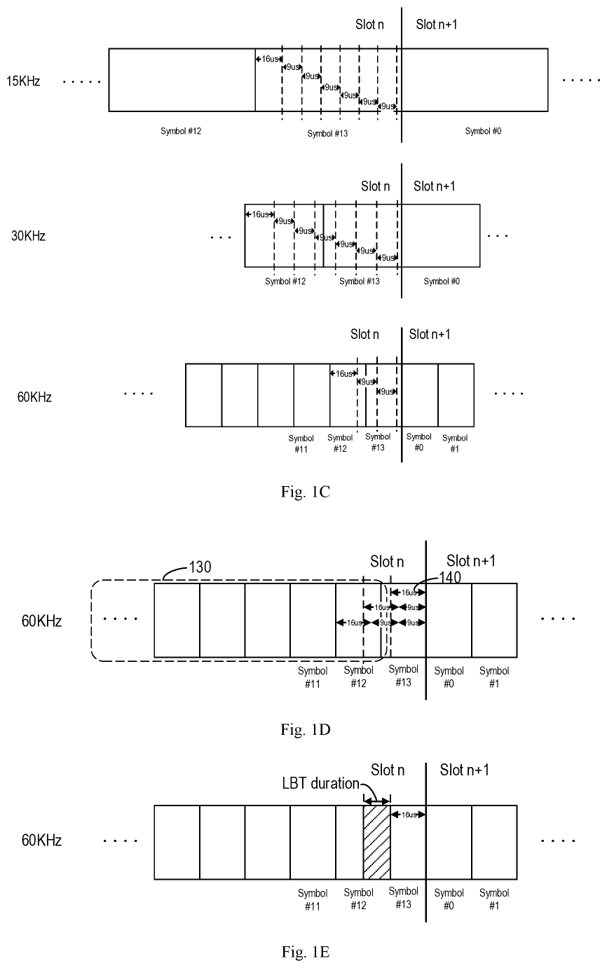

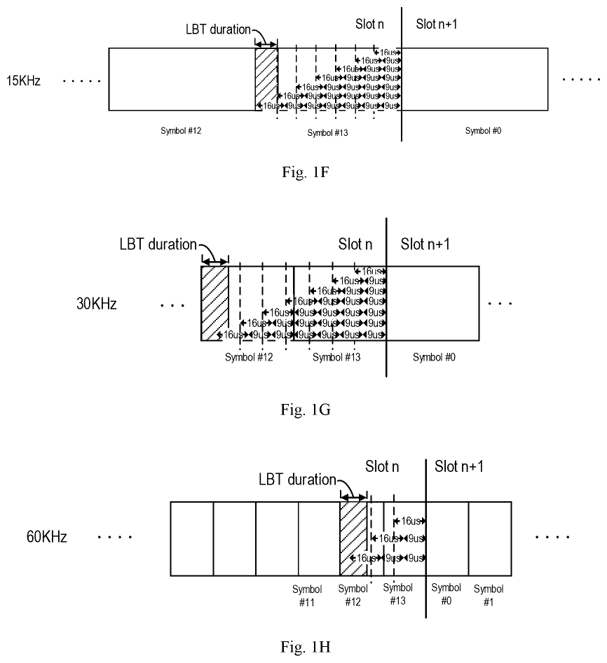

However, in this case, the configuration of the candidate starting positions may only consider the duration of a CPE without considering the durations for the corresponding LBT procedure. Furthermore, in the data transmission within a slot, the symbol #0 and #12 are configured to transmit the valid data, and the symbol #13 (i.e., the last symbol of the slot as mentioned above) can be regarded as a guard period. In this case, the data transmission in a slot maybe overlaps with the transmitted CPE or LBT procedure within symbol #12 of the slot (for example, in the Option 2). In turn, the coordination between a LBT procedure and the starting position for CPE are also not considered, since the CPE should after the symbol boundary and the LBT procedure. This may also result that the LBT procedure overlaps with the data transmission. For discussion clarity, the above configuration of starting positions is further discussed with reference to FIGS. 1D to 1H and is not discussed here.

In a specific example, the above two options are defined (agreement from RAN1 #112) for CPE transmission, as listed in below. In option 1, the multiple CPE starting positions are located in the symbol #13. In option 2, the multiple CP starting positions are located in symbol #12 and 13 #.

Agreement
A CPE can be transmitted from a CPE starting position before SL transmission for the
following two options:
Option 1: within the symbol just before the next AGC symbol
Option 2:
within the symbol just before the next AGC symbol for 15 kHz SCS
within at most 2 symbols just before the next AGC symbol for 30 or 60 kHz
SCS
FFS applicable scenario(s), condition(s) and channel type(s) to apply Option 1 or
Option 2

Furthermore, based on the discussion on SL-U and achieved WA/agreement from RAN1 #112bis. Two set of (multiple) CPE starting positions can be configured separately for the case of initiating a COT (i.e., transmission out of a COT) and transmission within a COT (i.e., the COT is shared). For example, the two set of CPE starting positions can be option 1 and option 2 as mentioned in above. The option 2 is used for initiating a COT (i.e., transmission out of a COT) and the option 1 is used for the case of transmission within in a COT (i.e., the COT is shared). For discussion clarity, the set of starting positions in the above two options are further shown with reference to FIGS. 1B to 1C and are not discussed here.

Agreement
For 15 kHz, 30 kHz and 60 kHz SCSs, a set of CPE starting candidate position(s) for
PSCCH/PSSCH is (pre-)configured or pre-defined in the spec (to be down-selected)
separately for transmission within COT and transmission outside COT.
Note: It is up to the (pre-)configuration or pre-definition in the spec (to be
down-selected) whether each set of CPE starting candidate position(s) associated
with Option 1 (1-symbol length) for CPE window or Option 2 (2-symbol length) for
CPE window and whether each set of CPE starting candidate position(s) include one
or multiple starting position(s)
FFS whether the set(s) of CPE starting positions are (pre-)configured/pre-defined
per priority
FFS values for the (pre-)configured/pre-defined CPE starting candidate position(s)
(including a default value) for each set, and whether the default value is the same or
different for different sets

As mentioned above, the terminal devices may use different LBT types to access a channel. The details regarding different LBT types are further presented as below.

Type 1 channel access procedure for UL in TS37.213

This subclause describes channel access procedures by a UE where the time duration
spanned by the sensing slots that are sensed to be idle before a UL transmission(s) is
random. The subclause is applicable to the following transmissions:
PUSCH/SRS transmission(s) scheduled or configured by eNB/gNB, or
PUCCH transmission(s) scheduled or configured by gNB, of
Transmission(s) related to random access procedure.
A UE may transmit the transmission using Type 1 channel access procedure after first
sensing the channel to be idle during the slot durations of a defer duration T_{d}, and after the
counter N is zero in step 4. The counter N is adjusted by sensing the channel for
additional slot duration(s) according to the steps described below.
1) set N = Nᵢₙᵢₜ, where Nᵢₙᵢₜ is a random number uniformly distributed between 0 and
CWₚ, and go to step 4;
2) if N > 0 and the UE chooses to decrement the counter, set N = N − 1;
3) sense the channel for an additional slot duration, and if the additional slot duration is
idle, go to step 4; else, go to step 5;
4) if N = 0, stop; else, go to step 2.
5) sense the channel until either a busy slot is detected within an additional defer duration
T_{d} or all the slots of the additional defer duration T_{d} are detected to be idle;
6) if the channel is sensed to be idle during all the slot durations of the additional defer
duration T_{d}, go to step 4; else, go to step 5;
If a UE has not transmitted a UL transmission on a channel on which UL transmission(s)
are performed after step 4 in the procedure above, the UE may transmit a transmission on
the channel, if the channel is sensed to be idle at least in a sensing slot duration Tₛₗ when
the UE is ready to transmit the transmission and if the channel has been sensed to be idle
during all the slot durations of a defer duration T_{d} immediately before the transmission. If
the channel has not been sensed to be idle in a sensing slot duration Tₛₗ when the UE first
senses the channel after it is ready to transmit, or if the channel has not been sensed to be
idle during any of the sensing slot durations of a defer duration T_{d} immediately before the
intended transmission, the UE proceeds to step 1 after sensing the channel to be idle during
the slot durations of a defer duration T_{d}.
The defer duration T_{d} consists of duration T_{f} = 16 us immediately followed by
mₚ consecutive slot durations where each slot duration is Tₛₗ = 9 us, and T_{f} includes an
idle slot duration Tₛₗ at start of T_{f}.
CW_{min, p} ≤ CWₚ ≤ CW_{max, p} is the contention window. CWₚ adjustment is described in
subclause 4.2.2.
C1W_{min, p} and CW_{max, p} are chosen before step 1 of the procedure above.
mₚ, CW_{min, p}, and CW_{max, p} are based on a channel access priority class p as shown in
Table 4.2.1-1, that is signalled to the UE.

Table 1 Channel Access Priority Class for UL

| Channel Access | | | | | |
|---|---|---|---|---|---|
| Priority | | | | | |
| Class (p) | mₚ | CW_{min, p} | CW_{max, p} | T_{ulmcot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, 255, 511, 1023} |
| 4 | 7 | 15 | 1023 | 6 ms or 10 ms | {15, 31, 63, 127, 255, 511, 1023} |

NOTE1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

Type 2 A/B UL channel access procedure, i.e., LBT Cat 2.

Type 2A UL channel access procedure
If a UE is indicated to perform Type 2A UL channel access procedures, the UE uses Type
2A UL channel access procedures for a UL transmission. The UE may transmit the
transmission immediately after sensing the channel to be idle for at least a sensing interval
Tₛₕₒᵣₜ_{_{—}}ᵤₗ = 25 us. Tₛₕₒᵣₜ_{_{—}}ᵤₗ consists of a duration T_{f} = 16 usimmediately followed by one
sensing slot and T_{f}includes a sensing slot at start of T_{f}. The channel is considered to be idle
for Tₛₕₒᵣₜ_{_{—}}ᵤₗ if both sensing slots of Tₛₕₒᵣₜ_{_{—}}ᵤₗ, are sensed to be idle.
Type 2B UL channel access procedure
If a UE is indicated to perform Type 2B UL channel access procedures, the UE uses Type
2B UL channel access procedure for a UL transmission. The UE may transmit the
transmission immediately after sensing the channel to be idle within a duration of T_{f} =
16 us. T_{f} includes a sensing slot that occurs within the last 9 us of T_{f}. The channel is
considered to be idle within the duration T_{f} if the channel is sensed to be idle for total of at
least 5 us with at least 4 us of sensing occurring in the sensing slot.
Type 2C UL channel access procedure
If a UE is indicated to perform Type 2C UL channel access procedures for a UL
transmission, the UE does not sense the channel before the transmission. The duration of
the corresponding UL transmission is at most 584 us.

That is, in some situations, the conflicts between the LBT procedure, transmitting CPE and the valid data transmission in a slot may occurred in the level of a symbol.

In view of the above, in order to improve the performance of a communication system, a scheme for sidelink communications is provided. In this scheme, a terminal device receives, from a network device, configuration information indicating at least one set of candidate starting positions for a CPE. The at least one set of candidate starting positions are determined based on an LBT type. Then, the terminal device determines, based on the configuration information, to perform or skip a data transmission on a symbol within a slot occupied by the terminal device for a sidelink transmission.

In this way, the conflicts between the LBT procedure, transmitting CPE and the valid data transmission in a slot can be solved, such that the sidelink communication performance is enhanced.

Principles and embodiments of the present disclosure will be described in detail below with reference to the accompanying drawings.

### Example Environment

FIG. 1A illustrates an example network environment 100 in which example embodiments of the present disclosure may be implemented. The environment 100, which may be a part of a communication network, includes terminal devices and network devices.

As illustrated in FIG. 1A, the network environment 100 may include a terminal device 110, a terminal device 120 and a network device 130. Just for sake of discussion and without any limitation, the first terminal device 110 and the second terminal device 120 may communicate with each other via sidelink channels. For example, the first terminal device 110 may transmit an acknowledge (ACK) or non-ACK message for a data transmission to the second terminal device 120, by transmitting the PSFCH to the second terminal device 120. In some cases, the terminal device may transmit multiple PSFCHs simultaneously.

It is to be understood that the number of terminal devices is given only for the purpose of illustration without suggesting any limitations. The system 100 may include any suitable number of network devices and/or terminal devices adapted for implementing embodiments of the present disclosure.

Communications in the network environment 100 may be implemented according to any proper communication protocol(s), comprising, but not limited to, the third generation (3G), the fourth generation (4G), the fifth generation (5G), 5G-Advanced or beyond (6G), wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: orthogonal frequency division multiplexing (OFDM), time division multiplexing (TDM), frequency division multiplexing (FDM), code division multiplexing (CDM), spatial division multiplexing (SDM) by means of beam-forming or multiple-input multiple-output (MIMO) transmission, carrier aggregation (CA), dual connectivity (DC), new radio unlicensed (NR-U) communication, Bluetooth, ZigBee, etc. The communication may be of any type, comprising but not limited to: machine type communication (MTC), enhanced mobile broadband (eMBB), massive machine type communication (mMTC), ultra-reliable low latency communication (URLLC), etc.

As mentioned above, in one solution, the starting positions for CPE may be configured in two options, i.e., Option 1 and Option 2.

FIG. 1B illustrates an example of a set of starting positions for CPE in Option 1. As shown in FIG. 1B, the set of starting positions for CPE are only configured within the symbol #13 of a slot. In the symbol #13 corresponding to the SCS of 15 kHz, there are seven starting positions. In the symbol #13 corresponding to the SCS of 30 kHz, there are three starting positions. In the symbol #13 corresponding to the SCS of 60 kHz, there is one starting position.

FIG. 1C illustrates an example of a set of starting positions for CPE in Option 2. As shown in FIG. 1B, the set of starting positions for CPE can be configured within the symbol #13 or symbol #12 of a slot. If the SCS is 15 kHz, the starting positions are only configured within symbol #13, and there are seven starting positions. If the SCS is 30 kHz, the starting positions are configured within symbols #12 and #13, and there are seven starting positions. If the SCS is 60 kHz, the starting positions are configured within symbols #12 and #13, and them are three starting positions.

In addition, in the Options 1 and 2, the conflicts between the LBT procedure, transmitting CPE and the valid data transmission in a slot may be occurred in the level of a symbol. FIG. 1D illustrates an example arrangement comprising candidate starting positions for CPE and a data transmission in an occupied slot.

As shown in FIG. 1D, the block 130 represents the (valid) data transmission that is transmitted in slot n. In an example, the data transmission may cross from symbol #0 to symbol #12 in slot n. In another example, the data transmission may cross from symbol #7 to symbol #12 in slot n. No matter in which cases, if the starting position or a corresponding LBT procedure overlaps with the symbol #12, the data transmission or the LBT procedure may be affected. That is, for the inside-COT case (i.e., the COT has been initiated or occupied, and the COT responding UE may contend the shared part of the COT), the data transmission is starting from symbol #0 to symbol #12 and symbol #13 is a guard period (GP). If option 2 is used, i.e., CPE transmitting on symbol #12 and #13, the transmitted data on symbol #12 will overlap with the CPE transmission on symbol #12.

In turn, it seems that Option 1 is better. However, even if Option 1 is adopted, there are still certain cases that the LBT procedure overlaps with symbol #12 in the slot n.

FIG. 1E illustrates an example arrangement comprising LBT procedure and a candidate starting position for CPE in an occupied slot. As shown in FIG. 1E, due to the minimum CPE duration is 16 us (as shown in FIG. 1E), there may be no enough time for:
i) type 2 LBT (type 2A: 25 us and type 2B: 16 us) for CPE and data transmission on slot n+1; and
ii) Rx/Tx switching (the UE performs reception from the COT initiator UE in slot n and then performs transmission in slot n+1 as COT shared UE), and Rx/Tx switching time is 13 us for FR1 and 9 us for FR2.

The Rx/Tx switching time is based on below conclusion, and switching time is included in LBT duration.

Conclusion
For defining the locations of CPE starting positions, RAN1 concludes that the NR-U
principle for switching gaps is reused in SL-U, that is:
The TX/RX switching gap is already included in the existing channel sensing structures
The RX/TX switching gap is already included in the existing channel sensing
structures

In addition, type 2 channel access measurements may be blocked by the last symbol of another UE transmission (i.e., symbol #12). In general, CPE starting positions should after symbol boundary and LBT type 2 duration time.

FIGS. 1F, 1G and 1H illustrate an example association between an LBT procedure, symbol boundary and a candidate starting position for CPE in an occupied slot. As shown in FIGS. 1F to 1H, the duration of the LBT procedure (or LBT type), the CPE starting positions and the valid data transmission on symbol #12 are not coordinated in any appropriate way.

In view of the above discussions and analysis, embodiments of this disclosure provide a solution for sidelink communications. It is to be understood that although the embodiments are mainly discussed with reference to the sidelink communication channels, the embodiments may be also applied to any other communication channels or links.

### Example Method

FIG. 2 illustrates an example signaling process 200 for configuring a set of candidate starting positions associated with LBT type according to some example embodiments of the subject disclosure. For the purpose of discussion, the flowchart 200 will be described with reference to FIG. 1A. It would be appreciated that although the process 200 has been described in the communication environment 100 of FIG. 1A, this process 200 may be likewise applied to other communication scenarios.

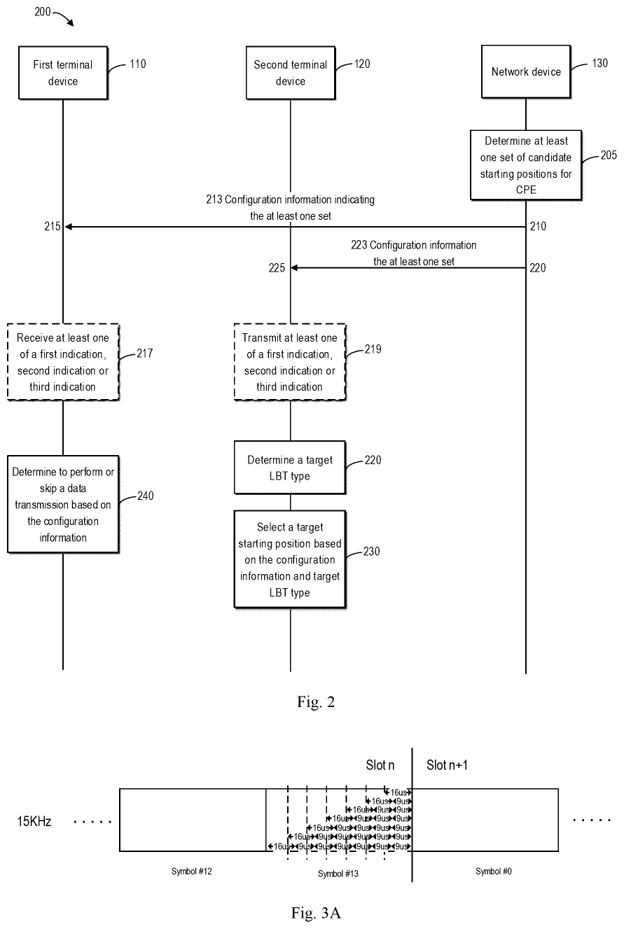

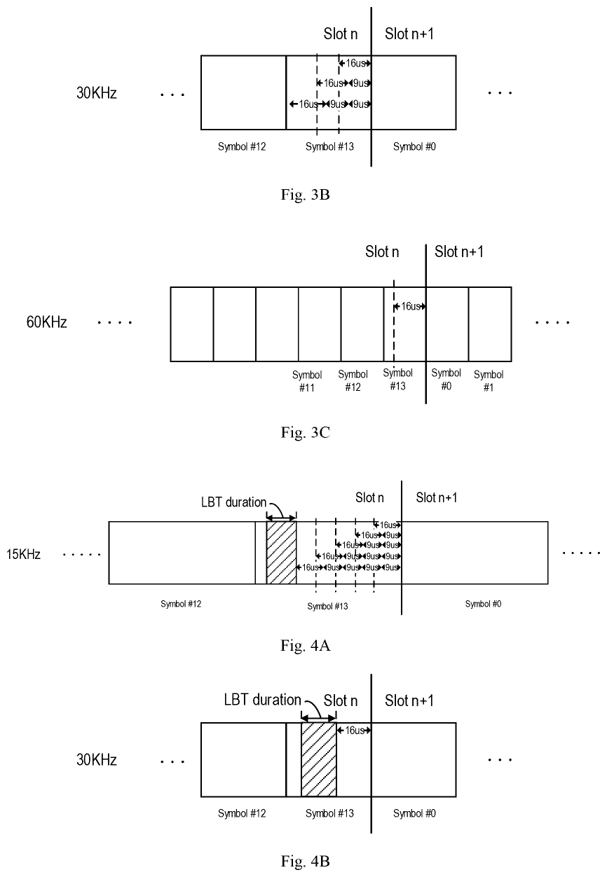

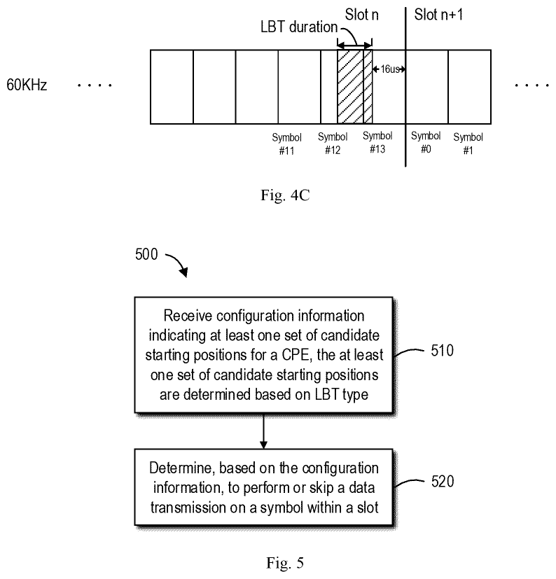

In the signaling process 200, the network device 130 determines (205) at least one set of candidate starting positions for CPE based on a LBT type. In some embodiments, the network device 130 may determine only one set of candidate starting positions for CPE based on one LBT type (for example, type 2C or type 2A). In addition or alternatively, the network device 130 may determine more than one set of candidate starting positions for CPE based on more than one LBT type (for example, type 2C and type 2B). That is, the set of candidate starting positions for CPE may correspond to a LBT type. If the set of candidate starting positions for CPE is determined based on different LBT types (for example, a first LBT type or a second LBT type), the candidate starting positions in the set of candidate starting positions may be different. Only for discussion clarity, the determination of the at least one set of candidate starting positions is further discussed with reference to FIGS. 3A-4C.

FIGS. 3A, 3B and 3C illustrate an example configuration of a set of candidate starting positions for CPE under a first LBT type in accordance with some embodiments of the present disclosure.

In some embodiments, the first LBT type may be the LBT type 2C of which the duration is 0 us. Alternatively, the set of candidate starting positions for CPE determined based on the first LBT type may be also applied to the case that the LBT procedure is not needed to be considered. In this disclosure, the set of candidate starting positions for CPE determined based on the first LBT type may be also referred to the first set of candidate starting positions. Since the LBT may be not considered or the LBT duration is 0 us, the candidate starting positions may be configured in the symbol #13 of the slot n without considering the duration required for the LBT procedure. In this case, if the slot n+1 is shared to other COT responding UE, the transmitted CPE in symbol #13 will not overlap with valid data transmission in slot n, since there is no additional LBT procedure, or the duration of LBT procedure is 0 us.

Although the above first set of candidate starting positions is discussed with reference to the duration of LBT is 0 us, it may also be applied with other LBT types of which duration is not 0 us. In this case, the first set candidate starting positions may be divided into more than one subset. If a selected candidate starting position (which may be also referred to target starting position) is within a certain subset, the corresponding LBT may also not overlap with symbol #12. Else, if the target starting position is not within the certain subset, the corresponding LBT may overlap with symbol #12. In this case, once determining that the target starting position is not within the certain subset, the terminal device occupying slot n may adjust data transmission on symbol #12 to coordinate with the LBT procedure for occupying slot n+1. For discussion clarity, the data transmission adjustment is further discussed in operation 240 as shown in FIG. 2, which is not discussed here.

As shown in FIGS. 3A to 3C, for different SCSs, the first set of candidate starting positions may distributed over the symbol #13 in the occupied slot n. The following Table 2 shows the candidate starting positions of the first set.

TABLE 2

| | CPE starting position | | | | | | |
|---|---|---|---|---|---|---|---|
| SCS | 1 | 2 | 3 | 4 | 5 | 6 | 7 |
| 15 KHz | 16 us | 16 + 1*9 us | 16 + 2*9 us | 16 + 3*9 us | 16 + 4*9 us | [16 + 5*9 us] | [16 + 6*9 us] |
| 30 KHz | 16 us | [16 + 1*9 us] | [16 + 2*9 us] | | | | |
| 60 KHz | [16 us] | | | | | | |

As shown in FIGS. 3A to 3B, the starting positions may be configured relative to the latter boundary of symbol #13. In some embodiments, the candidate starting positions without the square brackets of the table 2 may be the certain subset (which may be also referred to a first subset) of the first set. That is, if the target candidate starting position is one of the candidate starting positions with square brackets “[ ]” and the LBT procedure is not 0 us, the terminal device occupying the slot n should consider adjusting the data transmission on symbol #12. In other words, the usage of the set of candidate starting positions may be also associated with the LBT type without limiting to the first LBT type. In some embodiments, the first subset is obtained based on the symbol duration, LBT procedure duration and the starting position for CPE. In an example, if the symbol duration is 1/14 kHz=71.4 us and LBT type 2B (16 us) is used, the starting positions (16+5*9 us, 16+6*9 us) is in the first subset. In another example, if the symbol duration is 1/15 kHz=66.7 us and LBT type 2B is used, the starting positions (16+4*9 us, 16+5*9 us, 16+6*9 us) is in the first subset. In a further example, if the LBT type 2C is used, there is no first subset, and the each starting position may be determined by (the symbol duration−16 us)/K*9 us, wherein K is an integer.

That is, the one or more CPE starting position(s) is within one symbol and it is associated subcarrier spacing (SCS, 15 KHz, 30 KHz or 60 KHz). Furthermore, the CPE starting positions may not need to consider LBT type/duration, or the LBT type can be 2C.

In addition or alternatively, a second set of candidate starting positions for CPE may be determined based on a second LBT type of which the duration is not 0 us.

FIGS. 4A, 4B and 4C illustrate another example configuration of another set of candidate starting positions (which may be also referred to as a second set) for CPE under a second LBT type in accordance with some embodiments of the present disclosure.

In some embodiments, the second LBT type may comprise LBT type 2A and LBT type 2B which duration may be 25 us and 16 us. Since the duration of the LBT procedure is required to be considered, the candidate starting positions in the second set are distributed within a part of the symbol #12 for reserving duration of the LBT compared to the first set of candidate starting positions. The following Table 2 shows the candidate starting positions of the second set.

TABLE 3

| | CPE starting position | | | | | | |
|---|---|---|---|---|---|---|---|
| SCS | 1 | 2 | 3 | 4 | 5 | 6 | 7 |
| 15 KHz | 16 us | 16 + 1*9 us | 16 + 2*9 us | 16 + 3*9 us | 16 + 4*9 us | 16 + 5*9 us | 16 + 5*9 us |
| | | | | | | (x) | (x) |
| 30 KHz | 16 us | 16 + 5*9 us | 16 + 5*9 us | | | | |
| | | (x) | (x) | | | | |
| 60 KHz | [16 us] | | | | | | |

In this case, since the symbol duration of SCS having 60 kHz is smaller than “16 us+LBT procedure duration”, the first subset in the second set may comprise only one starting position (as shown by [16 us]). It is to be understood that although the first set and the second set are determined based on the first LBT type and the second LBT type respectively, the first set and second set may be not limited to be used with the corresponding LBT type because the data transmission on symbol #12 can be also adjusted (as mentioned above). In this way, only determining, based on the LBT type, one set of candidate starting positions is also possible, and the candidate starting position may be also used in association with the LBT type. Furthermore, although the above embodiments are discussed with reference to symbol #12 or 13, slot n and slot n+1, it may be also applied to any other time domain cases.

Referring back to FIG. 2, the network device 130 transmits (210, 220) configuration information 213 and 223 to the terminal device 110 and the device 120, respectively. The configuration information indicates the at least one set of candidate starting positions for CPE which is determined at operation 205. In some embodiments, the terminal device 110 may be the terminal device occupying the slot n, and the terminal device 120 may be another terminal device that is to occupy the slot n+1. Without any limitation, the terminal device 110 may be the COT initiating UE, or the COT responding UE occupying the slot n which is shared by the COT initiating UE. If the terminal device 110 is the COT responding UE, the terminal device 120 may be another COT responding UE different from the second terminal device 120.

After receiving (225) the configuration information 225, the terminal device 120 determines (220) a target LBT type based on a resource configuration for the terminal device or a received control channel transmission. For example, the indication regarding LBT type may be in a resource pool (pre-)configuration or a received control channel transmission (for example, via a downlink control information, DCI, a sidelink control information, SCI, or medium access control, MAC, signaling from the other UEs).

Then, the terminal device 120 selects (230), based on the target LBT type and the configuration information, a target starting position from the at least one set of candidate starting positions for occupying a sidelink channel. In some embodiments, the terminal device 120 (e.g., COT responding UE) may determine CPE starting position and/or corresponding LBT starting time based on SCS and/or LBT type/duration. The SCS may be also determined based on resource pool (pre-)configuration. In an example, if the target LBT type is type 2C, the terminal device 120 may determine the target starting position from the above first set of candidate starting positions. In turn, if the target LBT type is type 2A or 2B, the terminal device 120 may determine the target starting position from the above second set of candidate starting positions. Furthermore, without any limitation, there may be only one set of candidate starting positions. In addition, as mentioned above, the terminal device 110 may determine the target starting position further based on associated traffic priority. Only as an example, if the target LBT type is LBT type 2C, the SCS is 15 kHz, and the terminal device 120 has the highest priority, the terminal device 120 may select the starting position=16 us+6*9 us as listed in Table 1. Without any limitation, the terminal device 120 may select the target starting position in any other manners based on the LBT type and the configuration information.

In some embodiments, the terminal device 120 may further determine the starting time of the LBT procedure based on the target starting position, for example, a difference between the starting time and the target starting position may be the duration of the target LBT type. Then, the terminal device 110 may perform the LBT procedure for occupying the sidelink channel accordingly, for example, occupying the slot n+1.

Continuing to refer to FIG. 2, after receiving (215) the configuration information (213), the terminal device 110 determines (240), based on the configuration information, to perform or skip a data transmission on a symbol (for example, symbol #12) within a slot (for example, slot n) occupied by the terminal device 110 for a sidelink transmission. In some embodiments, the priority associated with the terminal devices and the target LBT type to be used are common among the terminal devices involved in the sidelink communication. Therefore, the terminal device 110 may be aware of the target LBT type to be used by the terminal device 120 that intends to occupy the slot n+1, based on the configuration information. Then, the terminal device 110 may be aware of the target starting position for the terminal device 120 to transmit the CPE or the starting time for the terminal device 120 to perform the LBT procedure, accordingly. Without any limitation, the terminal device 110 may be aware the starting position for transmitting CPE or starting time for performing LBT targeting to the slot n+1 in any other way.

In some embodiments, the terminal device 110 may be the COT initiating UE. In this case, the terminal device 110 may be aware that the slot n+1 will be shared to COT responding UE. For determining to perform or skip the data transmission on the first time unit, the terminal device 110 may determine, based on the configuration information, whether a LBT procedure to be performed by the terminal device 120 overlaps with the first time unit. The terminal device 110 may be also referred to the first terminal device 110, and the terminal device 120 may be also referred to as the second terminal device 120. If determining that the LBT procedure does not overlap with the symbol (i.e., the symbol #12), the first terminal device 110 may perform the data transmission on the symbol. If determining that the LBT procedure overlaps with the symbol, the first terminal device 110 may skip the data transmission on the symbol.

In an example, as mentioned above, the overlapping or non-overlapping between the symbol (for example, the symbol #12) and the LBT procedure to be performed by the second device 120 may be determined based on which candidate starting position is selected by the second device 120 as the target candidate starting position. In an example, the first terminal device 110 may determine, based on the configuration information, whether the target starting position selected by the second terminal device 120 is within the above first subset (i.e., the first subset comprising the candidate starting positions without the square brackets) of the at least one set of candidate starting positions. If determining that the target starting position is within the first subset, the first terminal device 110 may determine that the LBT procedure does not overlap with the symbol. If determining that the target starting position is not within the first subset, the first terminal device 110 may determine that the LBT procedure overlaps with the symbol.

That is, if the subsequent slot (i.e., slot n+1) will be shared to a COT responding UE, the first terminal device 110 occupying the slot n (for example, the COT initiating UE) may determine whether to skip the data transmission on symbol #12. In the case that the LBT procedure overlaps with symbol #12, the COT initiating UE may skip the data transmission on symbol #12. In the other case that the LBT procedure does not overlap with symbol #12, the COT initiating UE may perform the data transmission on symbol #12.

In some embodiments, the first terminal device 110 may have several alternative manners to skip the data transmission on symbol #12. The first terminal device 110 may perform, over at least one other symbol within the slot, a rate matching for the data transmission. Then, the first terminal device 110 may puncture the data transmission on the symbol accordingly. For example, the first terminal device 110 may perform rate matching for the data transmission over the symbols #0-#11 or the symbols #7-#11, and puncture the symbol #12. Alternatively, the first terminal device 110 may also perform the data transmission until the symbol #11, and stopping the data transmission on the symbol #12. That is, the first terminal device 110 may perform its data transmission until symbol #11 in slot n (i.e., preparing for data transmission until symbol #12 and puncturing the data transmission on symbol #12); or may prepare for data transmission until symbol #11.

In turn, if the overlapping is not occurred, the first terminal device 110 may perform data transmission until symbol #12 in slot n (i.e., do not puncture the data transmission on symbol #12), or to prepare for data transmission until symbol #12.

In addition or alternatively, the first terminal device 110 may be also not aware that the slot n+1 will be shared to COT responding UE (for example, the second terminal device 120). For example, the first terminal device 110 occupying slot n may be another COT responding UE different from the second terminal device 120. That is, the slot n is also shared by the COT initiating UE. In this case, the first terminal device 110 may receive an indication (for example, the following first, second or third indication) indicative of whether skip or perform data transmission on symbol #12.

In some embodiments, the first terminal device 110 may receive (217) a first indication to perform a data transmission until a symbol previous to the symbol. For example, the first terminal device 110 may receive an explicit indication in SCI (physical layer signaling) or MAC (higher layer signaling), to indicate the COT responding UE (for example, the terminal device 110) perform its data transmission until symbol #12 in slot n, or to prepare for data transmission until symbol #12. Alternatively, the first indication may indicate the COT responding UE performs its data transmission until symbol #11 in slot n (i.e., prepare for data transmission until symbol #12 and to puncture the data transmission on symbol #12), or to prepare for data transmission until symbol #11.

In addition or alternatively, the first terminal device 110 may receive (217) a second indication that there is another data transmission on another slot after the slot. For example, the first terminal device 110 may receive an explicit indication in SCI (physical layer signaling) or MAC (higher layer signaling), to indicate there is a transmission in subsequent slot or not. In this case, if there is a data transmission, the first terminal device 110 may determine to puncture the data transmission on symbol #12, else, do not puncture the data transmission on symbol #12.

In addition or alternatively, the first terminal device 110 may receive (217) a third indication of remaining time or a remaining slot of COT for the terminal device. For example, the first terminal device 110 may receive an implicit indication in SCI (physical layer signaling) or MAC (higher layer signaling), to indicate for example, the COT remaining time and remainder data transmission slot in the COT. In this case, the first terminal device 110 may implicitly determine whether to perform or skip the data transmission on symbol #12.

Without any limitation, the above first, second or third indication may be transmitted from any terminal device or network device that is aware of the occupancy situation of the COT. In an example, the second terminal device 120 that is to occupy the slot n+1 may transmit (219) the first, second or third indication, such that the first terminal device 110 and other terminal devices (for example, COT initiating UE and COT responding UE) can be aware the occupancy situation of the COT. Alternatively, the COT initiating UE that is aware of the occupancy situation of the COT may transmit the first, second or third indication to the first terminal device 110. Alternatively, the second terminal device 120 may transmit the first, second or third indication to the COT initiating UE, and the COT initiating UE may forward the first, second or third indication to the first terminal device 110. Alternatively, the COT initiating UE may also transmit the first, second or third indication to the COT responding UE which occupies the next slot. In addition, the COT responding UE may also transmit the first, second or third indication to another COT responding UE which will occupy the third slot, in an iterative way. It is to be understood that there may be any other way for informing the first, second or third indication.

In this way, the CPE starting position is configured within the one symbol in association with LBT type/duration. Furthermore, the UE behavior regarding data transmission has been defined, in order to indicate data transmission symbol number in subsequent slot. Moreover, the UE behavior has been defined, in order to perform or skip data transmission symbol number in transmission slot.

As such, the conflicts between the LBT procedure, transmitting CPE and the valid data transmission in a slot can be solved, such that the sidelink communication performance is enhanced.

FIG. 5 illustrates an example flowchart 500 of a method implemented at a terminal device according to example embodiments of the present disclosure. The method 500 can be implemented at the terminal device 110 shown in FIG. 1A. For the purpose of discussion, the method 500 will be described with reference to FIG. 1A. It is to be understood that the method 500 may include additional acts not shown and/or may omit some shown acts, and the scope of the present disclosure is not limited in this regard.

At 510, the terminal device 110 receives, from a network device 130, configuration information indicating at least one set of candidate starting positions for a CPE. The at least one set of candidate starting positions are determined based on a listen before talk (LBT) type. Then, at 520, the terminal device 110 determines, based on the configuration information, to perform or skip a data transmission on a symbol within a slot occupied by the terminal device for a sidelink transmission.

In some embodiments, the configuration information indicates at least one of a first set of candidate starting positions that are determined based on a first LBT type or a second set of candidate starting positions that are determined based on a second LBT type, and a first number of candidate starting positions in the first set is different from a second number of candidate starting positions in the second set.

In some embodiments, the first LBT type is an LBT type 2C and the second LBT type is an LBT type 2A or an LBT type 2B, and wherein the first number is greater than the second number.

In some embodiments, the terminal device 110 is a first terminal device 110, and the terminal device 110 may determine to perform or skip the data transmission on the symbol may comprising: determining, based on the configuration information, whether a LBT procedure to be performed by a second terminal device overlaps with the symbol; determining, based on determining that the LBT procedure does not overlap with the symbol, to perform the data transmission on the symbol; and determining, based on determining that the LBT procedure overlaps with the symbol, to skip the data transmission on the symbol. A starting time of the target LBT procedure is determined by the second terminal device based on the configuration information. The LBT procedure has a target LBT type selected by the second terminal device, and the LBT procedure is performed for occupying another slot after the slot.

In some embodiments, the terminal device 110 may determine to perform or skip the data transmission on the symbol by: determining, based on the configuration information, whether a target starting position selected by the second terminal device is within a first subset of the at least one set of candidate starting positions; determining, based on the determining that the target starting position is within the first subset, that the LBT procedure does not overlap with the symbol; and determining, based on the determining that the target starting position is not within the first subset, that the LBT procedure overlaps with the symbol.

In some embodiments, the terminal device 110 may skip the data transmission on the symbol by: performing, over at least one other symbol within the slot, a rate matching for the data transmission, and puncturing the data transmission on the symbol; or performing, via the transceiver, the data transmission until a symbol previous to the symbol, and stopping the data transmission on the symbol.

In some embodiments, the terminal device 110 may further receive, via the transceiver, a first indication to perform a data transmission until a symbol previous to the symbol; receive, via the transceiver, a second indication that there is another data transmission on another slot after the slot: or receive, via the transceiver, a third indication of remaining time or a remaining slot of a channel occupancy time (COT) for the terminal device.

In some embodiments, the terminal device 110 may determine to perform or skip the data transmission on the symbol comprises: determining, based on at least one of the first indication, the second indication or the third indication, to perform or skip the data transmission.

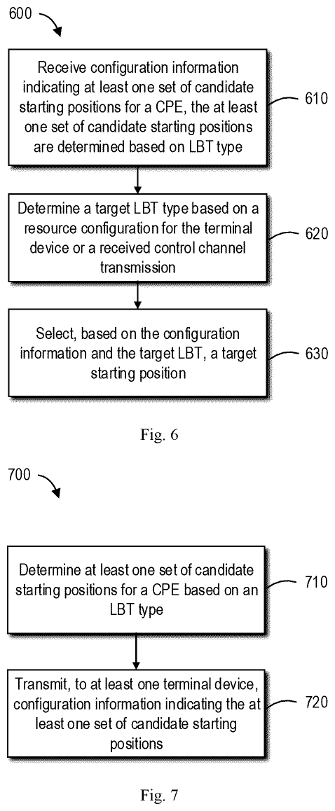

FIG. 6 illustrates an example flowchart 600 of a method implemented at a terminal device according to example embodiments of the present disclosure. The method 600 can be implemented at the terminal device 120 shown in FIG. 1A. For the purpose of discussion, the method 600 will be described with reference to FIG. 1A. It is to be understood that the method 600 may include additional acts not shown and/or may omit some shown acts, and the scope of the present disclosure is not limited in this regard.

At 610, the terminal device 120 receives, from a network device 130, configuration information indicating at least one set of candidate starting positions for CPE. The at least one set of candidate starting positions are determined based on a listen before talk (LBT) type. At 620, the terminal device 120 determines a target LBT type based on a resource configuration for the terminal device or a received control channel transmission. Then, at 630, the terminal device 120 selects, based on the target LBT type and the configuration information, a target starting position from the at least one set of candidate starting positions for occupying a sidelink channel.

In some embodiments, the configuration information indicates at least one of a first set of candidate starting positions that are determined based on a first LBT type or a second set of candidate starting positions that are determined based on a second LBT type, and a first number of candidate starting positions in the first set is different from a second number of candidate starting positions in the second set.

In some embodiments, the first LBT type is an LBT type 2C and the second LBT type is an LBT type 2A or an LBT type 2B, and wherein the first number is greater than the second number.

In some embodiments, the terminal device 120 may select the target starting position further based on a sidelink communication priority associated with the terminal device 120.

In some embodiments, the terminal device 120 may further determine, based on the target starting position, a starting time of a LBT procedure of the target LBT type; and perform, via the transceiver, the LBT procedure for occupying the sidelink channel.

In some embodiments, the terminal device 120 may further transmit a first indication to perform a data transmission until a symbol previous to the symbol; transmit a second indication that there is another data transmission on another slot after the slot; or transmit a third indication of remaining time or a remaining slot of a channel occupancy time (COT) for the terminal device.

FIG. 7 illustrates an example flowchart 700 of a method implemented at a terminal device according to example embodiments of the present disclosure. The method 700 can be implemented at the network device 130 shown in FIG. 1A. For the purpose of discussion, the method 700 will be described with reference to FIG. 1A. It is to be understood that the method 700 may include additional acts not shown and/or may omit some shown acts, and the scope of the present disclosure is not limited in this regard.

At 710, the network device 130 determines at least one set of candidate starting positions for CPE based on an LBT type. Then, at 720, the network device 130 transmits configuration information indicating the at least one set of candidate starting positions for CPE.

In some embodiments, the configuration information indicates at least one of a first set of candidate starting positions that are determined based on a first LBT type or a second set of candidate starting positions that are determined based on a second LBT type, and a first number of candidate starting positions in the first set is different from a second number of candidate starting positions in the second set.

In some embodiments, the first LBT type is an LBT type 2C and the second LBT type is an LBT type 2A or an LBT type 2B, and wherein the first number is greater than the second number.

In some embodiments, the network device 130 may further transmit a first indication to perform a data transmission until a symbol previous to the symbol; transmit a second indication that there is another data transmission on another slot after the slot; or transmit a third indication of remaining time or a remaining slot of a channel occupancy time (COT) for the terminal device.

### Example Apparatus

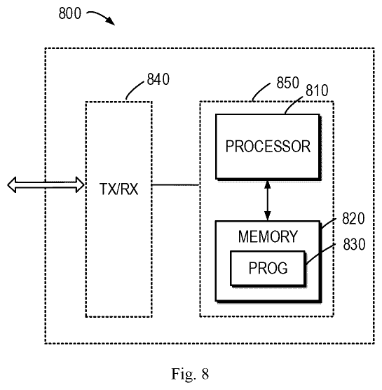

FIG. 8 illustrates a simplified block diagram of a device 800 that is suitable for implementing embodiments of the present disclosure. The device 800 can be considered as a further example implementation of the terminal device 110, terminal device 120 or network device 130 as shown in FIG. 1A. Accordingly, the device 800 can be implemented at or as at least a part of the terminal device 110, 120 or network device 130.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 830 is assumed to include program instructions that, when executed by the associated processor 810, enable the device 800 to operate in accordance with the embodiments of the present disclosure, as discussed herein with reference to FIGS. 1-7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, an apparatus capable of performing the method 500, 600 and 700 (for example, the terminal device 110, terminal device 120 or network device 130) may comprise means for performing the respective steps of the method 500, 600 and 700. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 500, 600 and 700.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

Clause 1. A terminal device comprising: a processor; and a transceiver coupled to the processor, wherein the processor is configured to: receive, via the transceiver from a network device, configuration information indicating at least one set of candidate starting positions for a cyclic prefix extension (CPE), wherein the at least one set of candidate starting positions are determined based on a listen before talk (LBT) type; and determine, based on the configuration information, to perform or skip a data transmission on a symbol within a slot occupied by the terminal device for a sidelink transmission.

Clause 2. The terminal device of clause 1, wherein: the configuration information indicates at least one of a first set of candidate starting positions that are determined based on a first LBT type or a second set of candidate starting positions that are determined based on a second LBT type, and a first number of candidate starting positions in the first set is different from a second number of candidate starting positions in the second set.

Clause 3. The terminal device of clause 2, wherein the first LBT type is an LBT type 2C and the second LBT type is an LBT type 2A or an LBT type 2B, and wherein the first number is greater than the second number.

Clause 4. The terminal device of any of clauses 1 to 3, wherein the terminal device is a first terminal device, and the processor is configured to determine to perform or skip the data transmission on the symbol by: determining, based on the configuration information, whether a LBT procedure to be performed by a second terminal device overlaps with the symbol; determining, based on determining that the LBT procedure does not overlap with the symbol, to perform the data transmission on the symbol; and determining, based on determining that the LBT procedure overlaps with the symbol, to skip the data transmission on the symbol, wherein a starting time of the target LBT procedure is determined by the second terminal device based on the configuration information, the LBT procedure has a target LBT type selected by the second terminal device, and the LBT procedure is performed for occupying another slot after the slot.

Clause 5. The terminal device of clause 4, wherein the processor is configured to determine to perform or skip the data transmission on the symbol by: determining, based on the configuration information, whether a target starting position selected by the second terminal device is within a first subset of the at least one set of candidate starting positions;

determining, based on the determining that the target starting position is within the first subset, that the LBT procedure does not overlap with the symbol; and determining, based on the determining that the target starting position is not within the first subset, that the LBT procedure overlaps with the symbol.

Clause 6. The terminal device of clause 1, wherein the processor is configured to skip the data transmission on the symbol by: performing, over at least one other symbol within the slot, a rate matching for the data transmission, and puncturing the data transmission on the symbol; or performing, via the transceiver, the data transmission until a symbol previous to the symbol, and stopping the data transmission on the symbol.

Clause 7. The terminal device of clause 1, wherein the processor is further configured to at least one of the following: receive, via the transceiver, a first indication to perform a data transmission until a symbol previous to the symbol; receive, via the transceiver, a second indication that there is another data transmission on another slot after the slot; or receive, via the transceiver, a third indication of remaining time or a remaining slot of a channel occupancy time (COT) for the terminal device.

Clause 8. The terminal device of clause 1, wherein determine to perform or skip the data transmission on the symbol comprises: determining, based on at least one of the first indication, the second indication or the third indication, to perform or skip the data transmission.

Clause 9. A terminal device comprising: a processor; and a transceiver coupled to the processor, wherein the processor is configured to: receive, via the transceiver from a network device, configuration information indicating at least one set of candidate starting positions for cyclic prefix extension (CPE), wherein the at least one set of candidate starting positions are determined based on a listen before talk (LBT) type; determine a target LBT type based on a resource configuration for the terminal device or a received control channel transmission; and select, based on the target LBT type and the configuration information, a target starting position from the at least one set of candidate starting positions for occupying a sidelink channel.

Clause 10. 10. The terminal device of clause 9, wherein: the configuration information indicates at least one of a first set of candidate starting positions that are determined based on a first LBT type or a second set of candidate starting positions that are determined based on a second LBT type, and a first number of starting positions in the first set is different from a second number of starting positions in the second set.

Clause 11. The terminal device of clause 10, wherein the first LBT type is an LBT type 2C and the second LBT type is an LBT type 2A or an LBT type 2B, and wherein the first number is greater than the second number.

Clause 12. The terminal device of clause 9, wherein the processor is configured to select the target starting position further based on a sidelink communication priority associated with the terminal device.

Clause 13. The terminal device of any of clause 9, wherein the processor is further configured to: determine, based on the target starting position, a starting time of a LBT procedure of the target LBT type; and perform, via the transceiver, the LBT procedure for occupying the sidelink channel.

Clause 14. The terminal device of any of clauses 9 to 13, wherein the processor is further configured to: transmit, via the transceiver, a first indication to perform a data transmission until a symbol previous to the symbol; transmit, via the transceiver, a second indication that there is another data transmission on another slot after the slot; or transmit, via the transceiver, a third indication of remaining time or a remaining slot of a channel occupancy time (COT) for the terminal device.

Clause 15. A network device comprising: a processor; and a transceiver coupled to the processor, wherein the processor is configured to: determine at least one set of candidate starting positions for cyclic prefix extension (CPE) based on a listen before talk (LBT) type; and transmit, via the transceiver to at least one terminal device, configuration information indicating the at least one set of candidate starting positions for CPE.

Clause 16. The network device of clause 15, wherein: the configuration information indicates at least one of a first set of candidate starting positions that are determined based on a first LBT type or a second set of candidate starting positions that are determined based on a second LBT type, and a first number of candidate starting positions in the first set is different from a second number of candidate starting positions in the second set.

Clause 17. The network device of clause 15, wherein the first LBT type is an LBT type 2C and the second LBT type is an LBT type 2A or an LBT type 2B, and wherein the first number is greater than the second number.

Clause 18. The network device of claim 15 or 16, wherein the processor is further configured to: transmit, via the transceiver, a first indication to perform a data transmission until a symbol previous to the symbol; transmit, via the transceiver, a second indication that there is another data transmission on another slot after the slot; or transmit, via the transceiver, a third indication of remaining time or a remaining slot of a channel occupancy time (COT) for the terminal device.

Clause 19. A method performed by a terminal device, comprising: receiving, at a terminal device from a network device, configuration information indicating at least one set of candidate starting positions for a cyclic prefix extension (CPE), wherein the at least one set of candidate starting positions are determined based on a listen before talk (LBT) type; and determining, based on the configuration information, to perform or skip a data transmission on a symbol within a slot occupied by the terminal device for a sidelink transmission.

Clause 20. A method performed by a terminal device, comprising: receiving, at a terminal device from a network device, configuration information indicating at least one set of candidate starting positions for cyclic prefix extension (CPE), wherein the at least one set of candidate starting positions are determined based on a listen before talk (LBT) type; determining a target LBT type based on a resource configuration for the terminal device or a received control channel transmission; and selecting, based on the target LBT and the configuration information, a target starting position from the at least one set of candidate starting positions for occupying a sidelink channel.

Clause 21. A method performed by a network device, comprising: determining at least one set of candidate starting positions for cyclic prefix extension (CPE) based on a listen before talk (LBT) type; and transmitting, via the transceiver to at least one terminal device, configuration information indicating the at least one set of candidate starting positions for CPE.

Clause 22. A non-transitory computer readable medium having program instructions stored thereon that, when executed by an apparatus, cause the apparatus at least to perform the method of any of clauses 19-21.

1. A terminal device for wireless communication, comprising:
at least one memory; and
at least one processor coupled to the at least one memory and configured to cause the terminal device to:
receive, from a network device, configuration information indicating at least one set of candidate starting positions for a cyclic prefix extension (CPE), wherein the at least one set of candidate starting positions are determined based on a listen before talk (LBT) type; and
determine, based on the configuration information, to perform or skip a data transmission on a symbol within a slot occupied by the terminal device for a sidelink transmission.

2. The terminal device of claim 1, wherein:
the configuration information indicates at least one of a first set of candidate starting positions that are determined based on a first LBT type or a second set of candidate starting positions that are determined based on a second LBT type, and
a first number of candidate starting positions in the first set is different from a second number of candidate starting positions in the second set.

3. The terminal device of claim 2, wherein the first LBT type is an LBT type 2C and the second LBT type is an LBT type 2A or an LBT type 2B, and wherein the first number is greater than the second number.

4. The terminal device of claim 3, wherein the terminal device is a first terminal device, and wherein the processor is configured to cause the terminal device to determine to perform or skip the data transmission on the symbol by:
determining, based on the configuration information, whether a LBT procedure to be performed by a second terminal device overlaps with the symbol;
determining, based on determining that the LBT procedure does not overlap with the symbol, to perform the data transmission on the symbol; and
determining, based on determining that the LBT procedure overlaps with the symbol, to skip the data transmission on the symbol,
wherein a starting time of the LBT procedure is determined by the second terminal device based on the configuration information, the LBT procedure has a target LBT type selected by the second terminal device, and the LBT procedure is performed for occupying another slot after the slot.

5. The terminal device of claim 4, wherein the at least one processor is configured to cause the terminal device to determine to perform or skip the data transmission on the symbol by:
determining, based on the configuration information, whether a target starting position selected by the second terminal device is within a first subset of the at least one set of candidate starting positions;
determining, based on the determining that the target starting position is within the first subset, that the LBT procedure does not overlap with the symbol; and
determining, based on the determining that the target starting position is not within the first subset, that the LBT procedure overlaps with the symbol.

6. The terminal device of claim 1, wherein the at least one processor is configured to cause the terminal device to skip the data transmission on the symbol by:
performing, over at least one other symbol within the slot, a rate matching for the data transmission, and puncturing the data transmission on the symbol; or
performing the data transmission until a symbol previous to the symbol, and stopping the data transmission on the symbol.

7. The terminal device of claim 1, wherein the at least processor is further configured to cause the terminal device to:
receive a first indication to perform a data transmission until a symbol previous to the symbol;
receive a second indication that there is another data transmission on another slot after the slot; or
receive a third indication of remaining time or a remaining slot of a channel occupancy time (COT) for the terminal device.

8. The terminal device of claim 1, wherein the at least one processor is configured to cause the terminal device to determine to perform or skip the data transmission on the symbol by:
determining, based on at least one of the first indication, the second indication or the third indication, to perform or skip the data transmission.

9. A terminal device for wireless communication, comprising:
at least one memory; and
at least one processor coupled with the at least one memory and configured to cause the terminal device to:
receive, from a network device, configuration information indicating at least one set of candidate starting positions for cyclic prefix extension (CPE), wherein the at least one set of candidate starting positions are determined based on a listen before talk (LBT) type;
determine a target LBT type based on a resource configuration for the terminal device or a received control channel transmission; and
select, based on the target LBT type and the configuration information, a target starting position from the at least one set of candidate starting positions for occupying a sidelink channel.

10. The terminal device of claim 9, wherein:
the configuration information indicates at least one of a first set of candidate starting positions that are determined based on a first LBT type or a second set of candidate starting positions that are determined based on a second LBT type, and
a first number of starting positions in the first set is different from a second number of starting positions in the second set.

11. The terminal device of claim 10, wherein the first LBT type is an LBT type 2C and the second LBT type is an LBT type 2A or an LBT type 2B, and wherein the first number is greater than the second number.

12. The terminal device of claim 9, wherein the at least one processor is configured to cause the terminal device to select the target starting position further based on a sidelink communication priority associated with the terminal device.

13. The terminal device of claim 9, wherein the at least one processor is further configured to cause the terminal device to:
determine, based on the target starting position, a starting time of a LBT procedure of the target LBT type; and
perform the LBT procedure for occupying the sidelink channel.

14. The terminal device of claim 9, wherein the at least one processor is further configured to cause the terminal device to:
transmit a first indication to perform a data transmission until a symbol previous to the symbol;
transmit a second indication that there is another data transmission on another slot after the slot; or
transmit a third indication of remaining time or a remaining slot of a channel occupancy time (COT) for the terminal device.

15. A network device for wireless communication, comprising:
at least one memory; and
at least one processor coupled with the at least one memory and configured to cause the network device to:
determine at least one set of candidate starting positions for cyclic prefix extension (CPE) based on a listen before talk (LBT) type; and
transmit, to at least one terminal device, configuration information indicating the at least one set of candidate starting positions for CPE.

16. The network device of claim 15, wherein:
the configuration information indicates at least one of a first set of candidate starting positions that are determined based on a first LBT type or a second set of candidate starting positions that are determined based on a second LBT type, and
a first number of candidate starting positions in the first set is different from a second number of candidate starting positions in the second set.

17. The network device of claim 15, wherein the first LBT type is an LBT type 2C and the second LBT type is an LBT type 2A or an LBT type 2B, and wherein the first number is greater than the second number.

18. The network device of claim 15, wherein the at least one processor is further configured to cause the network device to:
transmit a first indication to perform a data transmission until a symbol previous to the symbol;
transmit a second indication that there is another data transmission on another slot after the slot; or
transmit a third indication of remaining time or a remaining slot of a channel occupancy time (COT) for the terminal device.

19. A method performed by a terminal device, the method comprising:
receiving, from a network device, configuration information indicating at least one set of candidate starting positions for a cyclic prefix extension (CPE), wherein the at least one set of candidate starting positions are determined based on a listen before talk (LBT) type; and
determining, based on the configuration information, to perform or skip a data transmission on a symbol within a slot occupied by the terminal device for a sidelink transmission.

20.-22. (canceled)

23. The method of claim 19, wherein the configuration information indicates at least one of a first set of candidate starting positions that are determined based on a first LBT type or a second set of candidate starting positions that are determined based on a second LBT type, and wherein a first number of candidate starting positions in the first set is different from a second number of candidate starting positions in the second set.
